(19) United States
(12) Patent Application Publication
(10) Pub. No.: US 2008/0218715 A1
(43) Pub. Date: Sep. 11, 2008

(54) IMMERSION EXPOSURE METHOD OF AND IMMERSION EXPOSURE APPARATUS FOR MAKING EXPOSURE IN A STATE WHERE THE SPACE BETWEEN THE PROJECTION LENS AND SUBSTRATE TO BE PROCESSED IS FILLED WITH A LIQUID

(76) Inventors: Masayuki HATANO, Yokohama-shi (JP); Shinichi Ito, Yokohama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/044,439

(22) Filed: Mar. 7, 2008

(30) Foreign Application Priority Data
Mar. 9, 2007 (JP) 2007-060668

(51) Int. Cl. G03B 27/42

(52) U.S. Cl. 355/53; 355/77

(57) ABSTRACT

An immersion exposure method is disclosed which, while causing a relative movement of an immersion area formed so as to intervene between a substrate to be exposed on an exposure stage and a projection lens to the substrate, exposes an irradiation area of the substrate covered with the immersion area. An exposure stage is moved in a first direction, thereby exposing a first exposure area of the substrate. The exposure stage is moved in a second direction opposite to the first direction, thereby exposing a second exposure area adjoining the first exposure area. In a state where the second exposure area is held inside the immersion boundary of the immersion area, the exposure stage is moved from the movement end position of the exposure stage in a first exposure moving process to the movement start position of the exposure stage in a second exposure moving process.

### CROSS-REFERENCE TO RELATED APPLICATIONS

This application is based upon and claims the benefit of priority from prior Japanese Patent Application No. 2007-060668, filed Mar. 9, 2007, the entire contents of which are incorporated herein by reference.

### BACKGROUND OF THE INVENTION

1. Field of the Invention

This invention relates to an immersion exposure method of and an immersion exposure apparatus for making exposure in a state where the space between the projection lens and substrate to be processed is filled with a liquid, such as water.

2. Description of the Related Art

To cope with the recent trend toward the miniaturization of semiconductor device patterns, an immersion-type scan exposure apparatus (immersion exposure apparatus) which makes exposure in a state where the space between the projection lens and substrate to be processed is filled with a liquid, such as water, has been under development.

Use of an immersion exposure apparatus makes it possible to improve the resolution limit without changing the exposure wavelength or increase the focal depth.

However, in an immersion exposure where an immersion area is formed locally on a substrate to be exposed and exposure is made via the immersion area moving relative to the substrate, water residuals or bubbles leading to the deterioration of the image forming performance are liable to develop at the immersion boundary.

This causes a problem: when the immersion area is moved from a first exposure area exposed on a first scan of the irradiation slit area to a second exposure area exposed on a second scan, bubbles developed in the second exposure area degrade the image forming performance of the second exposure area under the condition that the immersion boundary overlaps with the second exposure area.

When foreign matter has got into the immersion area, substances produced from the resist have an adverse effect on the imaging characteristic of the exposure apparatus. Measures against this have already been proposed (e.g., Jpn. Pat. Appln. KOKAI Publication No. 2006-114765).

### BRIEF SUMMARY OF THE INVENTION

According to a first embodiment of the invention, there is provided an immersion exposure method of, while causing a relative movement of an immersion area formed so as to intervene between a substrate to be exposed on an exposure stage and a projection lens to the substrate, exposing an irradiation area of the substrate covered with the immersion area, the immersion exposure method comprising: moving the exposure stage in a first direction and making exposure in a state where a first exposure area of the substrate is held inside the immersion boundary of the immersion area; moving the exposure stage from a movement end position of the exposure stage to a movement start position of a second exposure area adjacent to the first exposure area in a state where the second exposure area is held inside the immersion boundary of the immersion area; and moving the exposure stage in a second direction opposite to the first direction and exposing the second exposure area in a state where the second exposure area is held inside the immersion boundary of the immersion area.

According to a second embodiment of the invention, there is provided an immersion exposure apparatus comprising: an exposure stage which holds a substrate to be exposed; a mask holding mechanism which is configured to hold a photomask; an optical projection system which is configured to project a pattern of the photomask on the substrate and expose the pattern; and an immersion area forming mechanism which is configured to form a liquid immersion area between a projection lens of the optical projection system and the substrate and which forms an immersion area whose diameter is larger than v²/a<IL−2CL, if the maximum length in the scanning direction of an exposure area exposed in one scan is CL, the absolute value of the speed of the exposure stage in the scanning exposure is v, the absolute value of the acceleration and deceleration in the scanning direction of the exposure stage during the movement of the exposure stage between the scanning exposure and the next scanning exposure is a, wherein the optical projection system scans and exposes the pattern of the photomask via the immersion area above the substrate at a constant speed, while the exposure stage is being moved with respect to the projection lens.

According to a third embodiment of the invention, there is provided an immersion exposure apparatus comprising: an exposure stage which holds a substrate to be exposed; a mask holding mechanism which is configured to hold a photomask; an optical projection system which is configured to project a pattern of the photomask on the substrate and expose the pattern; and an immersion area forming mechanism which is configured to form a liquid immersion area between a projection lens of the optical projection system and the substrate and which forms an immersion area whose diameter IL is larger than (H+CL)×2, if the length in a first direction of each of a first exposure area and a second exposure area is CL and the moving width in the first direction of the exposure stage in moving the exposure stage is H, wherein the optical projection system scans and exposes the pattern of the photomask via the immersion area above the substrate at a constant speed, while the exposure stage is being moved with respect to the projection lens.

### BRIEF DESCRIPTION OF THE SEVERAL VIEWS OF THE DRAWING

FIG. 1 is a schematic diagram showing an immersion projection exposure apparatus according to an embodiment of the embodiment;

FIG. 2 is a plan view to help explain the relationship between an immersion area and an irradiation slit area;

FIG. 3 is a plan view showing the arrangement of a plurality of exposure areas formed on a substrate to be exposed;

FIGS. 4A to 4C show the way the irradiation slit area scans the exposure areas from top down;

FIGS. 5A to 5C show the way the irradiation slit area scans the exposure areas from bottom up;

FIG. 6 is a plan view to help explain the way the irradiation area moves when a plurality of exposure areas on the substrate are scanned and exposed sequentially in the embodiment;

FIG. 7 is an enlarged plan view of a part of FIG. 6;

FIG. 8 is a plan view to help explain the way the immersion area moves in a non-exposure moving process in the immersion scanning exposure according to the embodiment;

FIG. 9 is a plan view to help explain the way the immersion area moves in a second exposure moving process in the immersion scanning exposure according to the embodiment;

FIG. 10 is a plan view to help explain the way the immersion area moves in a non-exposure moving process in a conventional immersion scanning exposure; and

FIG. 11 is a plan view to help explain the way the immersion area moves in a second exposure moving process in the conventional immersion scanning exposure.

### DETAILED DESCRIPTION OF THE INVENTION

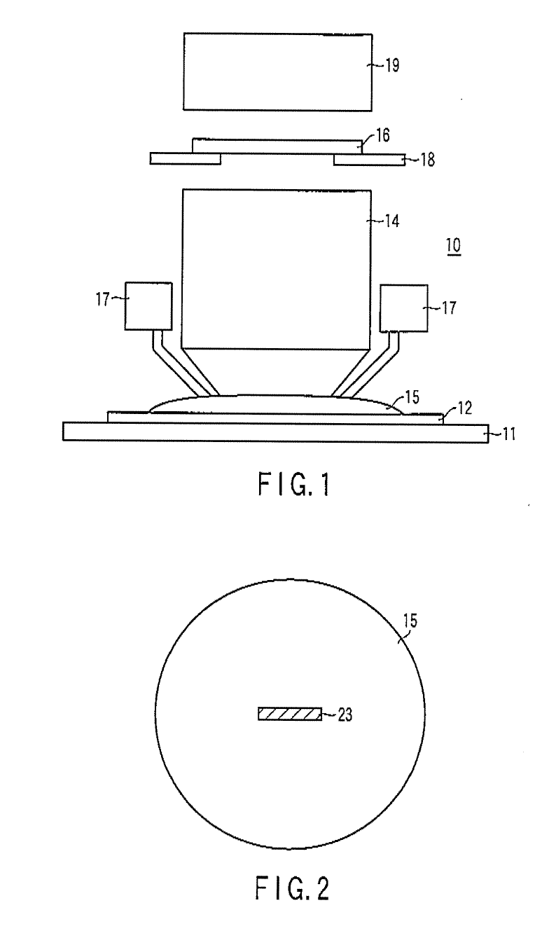

FIG. 1 shows an immersion projection exposure apparatus 10 according to an embodiment of the invention.

The immersion projection exposure apparatus 10 comprises an exposure stage 11, a projection lens 14, a water supply and recovery mechanism (immersion area forming mechanism) 17, a mask stage (mask holding mechanism) 18, and a lighting system 19. The lighting system 19 and projection lens 14 constitute an optical projection system.

In FIG. 1, a substrate to be exposed 12 is put on and fixed to the exposure stage 11. The substrate 12 moves as the exposure stage 11 moves horizontally. On the mask stage 18, a photomask 16 in which a design pattern, such as a semiconductor element pattern, has been formed is placed. As the mask stage 18 moves horizontally, the photomask 16 also moves accordingly.

The lighting system 19 irradiates the photomask 16 with exposure light. The space between the substrate 12 and projection lens 14 is filled with the water in the immersion area 15. The exposure light projected from the projection lens 14 passes through the water layer in the immersion area 15 and reaches the irradiation slit area 23 (irradiation area) shown in FIG. 2.

FIG. 2 is a diagram obtained when the relationship between the immersion area 125 and irradiation slit area 23 is viewed from above. The irradiation slit area 23 is a slit-like area which is located in the center of the immersion area 15 and is actually irradiated with the exposure light. The shape of the irradiation slit area 23 is determined by the slit made in the lighting system 19.

The image of the mask pattern on the photomask 16 is projected on a photoresist (not shown) at the surface of the substrate 12 corresponding to the irradiation slit area 23, thereby forming a latent image in the photoresist.

Next to the projection lens 14, there is provided the water supply and recovery mechanism 17 for supplying and recovering water to and from the immersion area 15 between the substrate 12 and projection lens 14. The water is supplied and discharged in synchronization with scanning exposure.

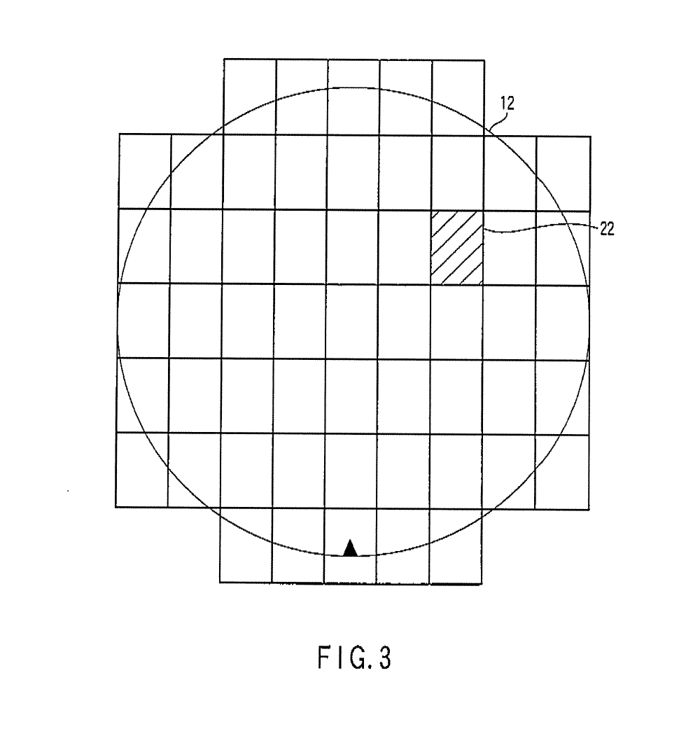

FIG. 3 shows the arrangement of a plurality of exposure areas formed on the substrate 12. The mask pattern drawn on a single mask is projected on a rectangular exposure area on the substrate 12 by the scanning exposure.

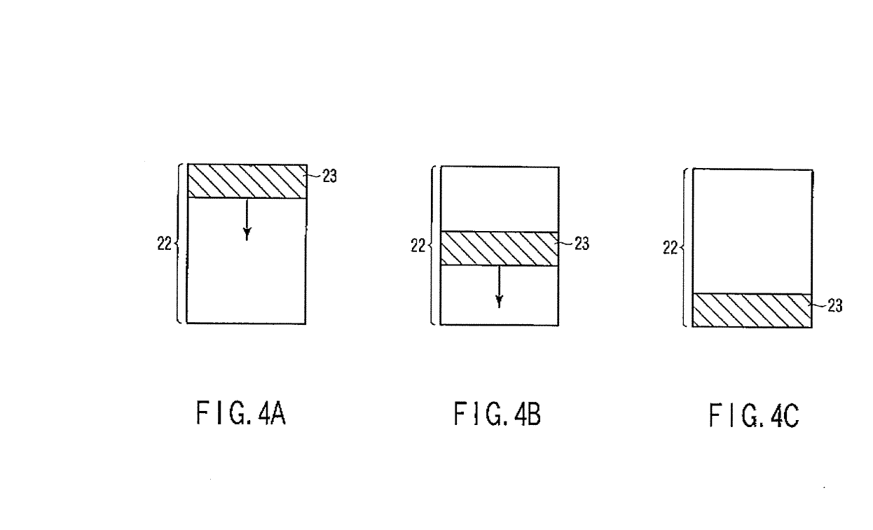

In the scanning exposure, the exposure stage 11 and substrate 12 are moved in one direction with respect to the projection lens 14, thereby causing the irradiation slit area 23 to scan the exposure area 22 from the top to bottom of the sheet as shown in, for example, FIGS. 4A to 4C.

At this time, since the top surface of the immersion area 15 maintains the relationship as shown in FIG. 1, while being in contact with the projection lens 14, the under surface of the immersion area 15 moves over the substrate 12, while being in contact with the substrate 12. Moreover, in the scanning exposure, the photomask 16, together with the mask stage 18, is also moved horizontally with respect to the direction in which the substrate 12 moves, while being irradiated with the exposure light. Although depending on the configuration of the lens system, the moving direction of the substrate is generally opposite to that of the photomask.

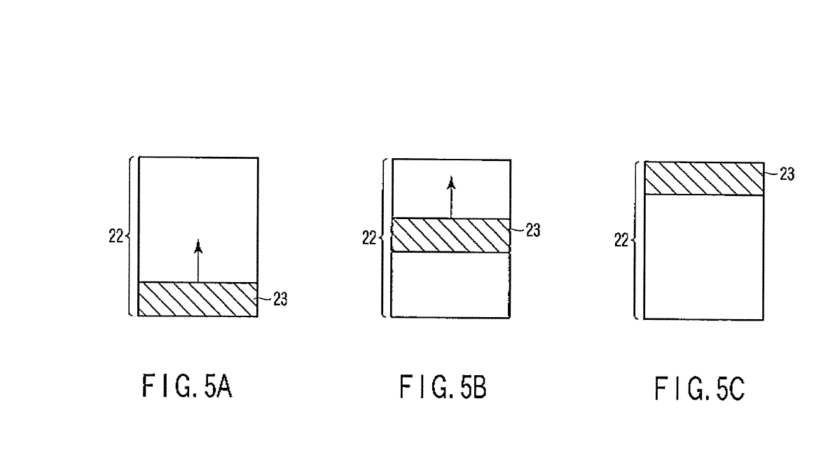

Alternatively, the exposure stage 11 is moved in the direction opposite to the aforementioned direction with respect to the projection lens 14, which causes the irradiation slit area 23 to scan the exposure area 22 from the bottom to top of the sheet as shown in FIGS. 5A to 5C.

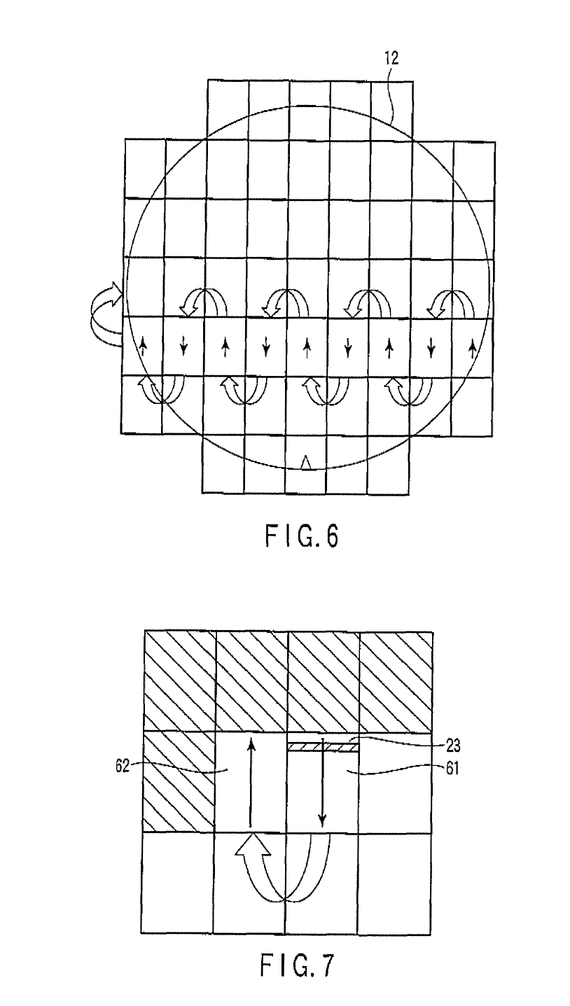

Hereinafter, an immersion exposure method according to the embodiment will be explained. FIGS. 6 and 7 show the way the irradiation region moves when a plurality of exposure areas on the substrate to be exposed 12 are scanned and exposed sequentially. FIG. 7 is an enlarged view of a part of FIG. 6.

First, a first exposure area 61 of FIG. 7 is scanned and exposed. The exposure stage 11 is moved in one direction (first direction), which causes the irradiation slit area 23 starting to scan from the upper end of the first exposure area 61 to reach the lower end of the first exposure area 61 (first exposure moving process).

Thereafter, the exposure stage 11 is further moved in such a manner that its moving direction is changed from the position of the exposure stage 11 when the irradiation slit area 23 reached the lower end of the first exposure area 61 to the position of the exposure stage 11 when the irradiation slit area 23 reaches the lower end of a second exposure area 62 (non-exposure moving process). The first exposure area 61 is adjacent to the second exposure area 62 in a direction perpendicular to the scanning direction (first direction) in the first exposure moving process.

After the irradiation slit area 23 has reached the first exposure area 61, the second exposure area 62 is exposed, while the exposure stage 11 is being moved horizontally in the opposite direction (second direction) to that when the first exposure area 61 was exposed (second exposure moving process).

After the aforementioned exposure moving operations have been carried out on a row of horizontal exposure areas of the substrate 12, the exposure stage is moved to the next upper row and makes exposure repeatedly as described above. Finally, all of the exposure areas of the substrate 12 have been scanned and exposed.

As a result of the movement of the exposure stage 11 and substrate 12 in the first and second exposure moving processes and the non-exposure moving process, the immersion area 15 in contact with the projection lens 14 moves relative to the substrate to be exposed 12.

When the movement direction of water constituting the immersion area 15 changes in a relative movement of the immersion area 15 between exposure areas in the non-exposure moving process, microbubbles are liable to develop at an immersion boundary 151 between the immersion area 15 and air shown in FIG. 8. FIG. 8 shows the way the immersion area 15 moves in the non-exposure moving process in the embodiment. Since the microbubbles have a life time, if microbubbles develop in a certain exposure area immediately before exposure, this causes the problem of degrading the image forming performance of the exposure area.

In the immersion exposure method of the embodiment, as shown in FIG. 8, the immersion boundary 151 does not pass over the exposure area 62, the next exposure area, in the non-exposure moving process between the first and second exposure moving processes. That is, in the non-exposure moving process, the second exposed area 62 is held inside the immersion boundary 151.

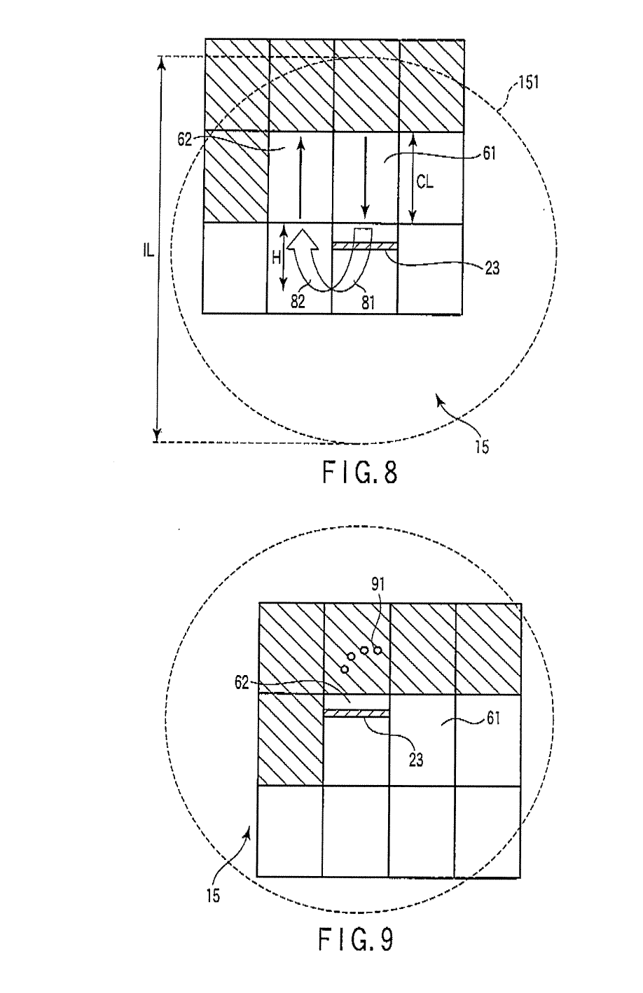

Accordingly, even it bubbles develop at the immersion boundary 151, they are outside the second exposure area 61. Consequently, as seen from FIG. 9 which shows the way the immersion area 15 moves in the second exposure moving process in the embodiment, since bubbles 91 do not exist in the second exposure area 62 when the second exposure area 62 is exposed, the image forming performance of the second exposure area 62 is not degraded.

Even if in a previous moving process, bubbles occurred as a result of the immersion boundary 151 having passed over the second exposure area 62, it is conceivable that the life time has elapsed at the time that the second exposure area is exposed and therefore the bubbles have disappeared. Therefore, in the non-exposure moving process, the process immediately before the second exposure moving process, bubbles are prevented from occurring in the second exposure area 62, which makes it possible to avoid the deterioration of the image forming performance of the second exposure area 62.

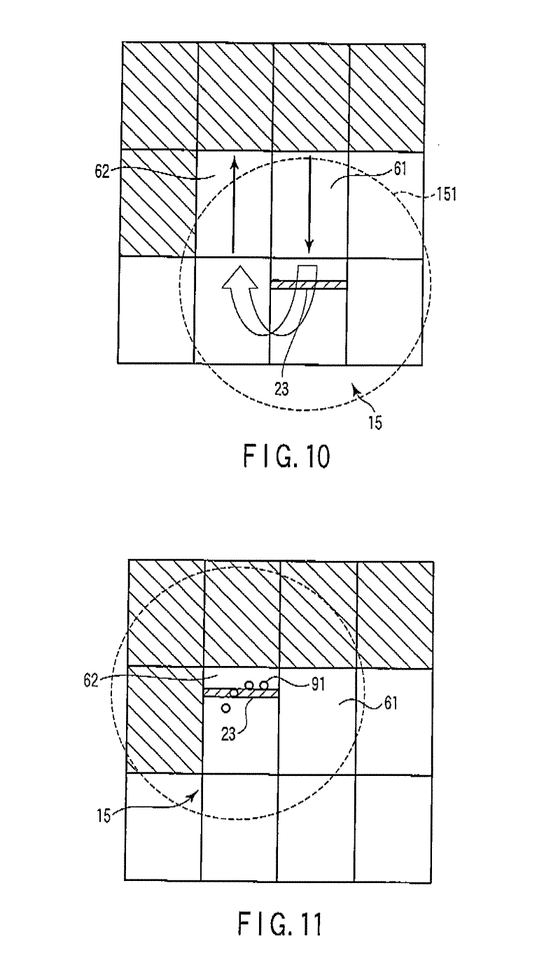

In a conventional immersion exposure method, however, the immersion boundary 151 passes over the second exposure area 62 in the non-exposure moving process as shown in FIG. 10. Accordingly, as shown in FIG. 11, the irradiation slit area 23 scans and exposes the second exposure area 62 before the life time of the bubbles 92 occurred in the immersion area 15 on the second exposure area 61 has elapsed, which causes a problem; the existence of the bubbles 91 degrades the image forming performance of the second exposure area 62.

In the immersion scanning exposure of the embodiment, microbubbles are prevented from occurring in the immersion liquid in the exposure area immediately before exposure, thereby making it possible to avoid the above problem.

In the non-exposure moving process, the second exposure area 62 is held inside the immersion boundary 151. However, the deterioration of the image forming performance of the second exposure area 62 can be avoided more reliably by holding the second exposure area 62 inside the immersion boundary 151 by preventing the immersion boundary 151 from passing over the second exposure area 62 even in the first exposure moving process, the preceding process.

The conditions for holding the second exposure area 62 inside the immersion boundary in the non-exposure moving process will be described in detail below.

As shown in FIG. 8, let the diameter of the immersion area be IL [mm], the length of each of the first exposure area 61 and second exposure area 62 in the direction in which scanning and exposure are performed (first direction or second direction) be CL [mm], and the moving width of the irradiation slit area 23 in the scanning direction in the non-exposure moving process, or the moving width of the exposure stage 11 in the scanning direction, be H [mm].

The condition for the second exposure area 62 to be held inside the immersion boundary 151 is that CL+H is smaller than the radius IL/2 of the immersion area.

Specifically, if the diameter IL [mm] of the immersion area is given, the length CL [mm] of each of the first exposure area 61 and second exposure area 62 in the scanning direction and the moving width H [mm] of the exposure stage 11 in the scanning direction in the non-exposure moving process are set so as to meet the following expression;

H+CL<IL/2 (1)

In other words, the diameter IL of the immersion area 15 is set so as to be larger than (H+CL)×2.

The above condition, that is, the condition represented by Expression 1, can be expressed differently under the following assumption.

Suppose the exposure stage 11 moves at a constant speed of v [mm/sec] in the scanning direction (first direction) in the first exposure moving process and at a constant speed of −v [mm/sec] in the opposite direction in the second exposure moving process. The absolute value of the speed of the exposure stage 11 in the first exposure moving process and that in the second exposure moving process are both v.

Furthermore, suppose the exposure stage 11 moves at a constant acceleration in the first direction whose absolute value is a [mm/sec²] when the moving speed v in the first direction changes to the moving speed −v in the second direction in the transition from the first-half movement 81 to the second-half movement 82.

On the assumption that the movement of the exposure stage 11 in the non-exposure moving process is moved at the constant deceleration, the moving width H of the exposure stage 11 in the scanning direction (first direction or second direction) in the non-exposure moving process is expressed as:

H=V²/(2a) (2)

where the constant moving speed is v [mm/sec] and the absolute value of each of the acceleration and deceleration is a [mm/sec2].

Substituting this into Expression 1 gives

V²/a<IL−2LC (3)

Accordingly, if the diameter of the immersion area is IL [mm] and the length of each of the first exposure area 61 and second exposure area 62 in the scanning direction is CL [mm], the constant moving speed v [mm/sec] and the absolute value a [mm/sec²] of each of the acceleration and deceleration are determined so as to satisfy Expression 3. Since these parameters are the setting parameters for an immersion scanning exposure apparatus, the user can set them so as to satisfy Expression 3.

Furthermore, in the non-exposure moving process, when the condition for the second exposure area 62 to be held inside the immersion boundary 151 is viewed from the immersion exposure apparatus side, it will be described as follows.

As described above, it is assumed that the exposure stage 11 moves at a constant speed whose absolute value is v [mm/sec] in a direction in the first exposure moving process and in the opposite direction in the second exposed moving direction and that the exposure stage 11 moves at a constant acceleration or deceleration whose absolute value is a [mm/sec²] in the non-exposure moving process. Moreover, suppose the maximum length of the (first and second) exposure areas exposed in one scanning exposure is CL [mm].

Even if the user can select the constant moving speed v [mm/sec] and the absolute value a [mm/sec²] of each of the acceleration and deceleration in a specific range of values, the second exposure area 62 can be held inside the immersion boundary 151, provided that the immersion area forming mechanism, such as the water supply and recovery mechanism 17 of the immersion exposure apparatus can control the diameter IL [mm] of the immersion area 15 in such a manner that an immersion area whose diameter IL is larger than V²/a+2CL can be formed, or the following condition is met:

IL>v²/a+2CL (4)

Since satisfying the above-described condition makes it possible to prevent the immersion boundary 151 from passing over the second exposure area 62 in the non-exposure moving process and enable the second exposure area 62 to be held inside the immersion boundary 151, the deterioration of the image forming performance of the second exposure area 62 in the second exposure moving process can be avoided.

Furthermore, it goes without saying that the deterioration of the image forming performance of the second exposure area 62 can be avoided more reliably by holding the second exposure area 62 inside the immersion boundary 151 in the first exposure moving process in the preceding process in addition to the above condition for the second exposure area 62 to be held inside the immersion boundary 151 in the non-exposure moving process.

As described above, according to one aspect of the invention, an immersion exposure method and an immersion exposure apparatus which are capable of avoiding the deterioration of the image forming performance in immersion exposure can be provided.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An immersion exposure method of, while causing a relative movement of an immersion area formed so as to intervene between a substrate to be exposed on an exposure stage and a projection lens to the substrate, exposing an irradiation area of the substrate covered with the immersion area, the immersion exposure method comprising:
moving the exposure stage in a first direction and making exposure in a state where a first exposure area of the substrate is held inside the immersion boundary of the immersion area;
moving the exposure stage from a movement end position of the exposure stage to a movement start position of a second exposure area adjacent to the first exposure area in a state where the second exposure area is held inside the immersion boundary of the immersion area; and
moving the exposure stage in a second direction opposite to the first direction and exposing the second exposure area in a state where the second exposure area is held inside the immersion boundary of the immersion area.

2. The immersion exposure method according to claim 1, wherein the second exposure area is held inside the immersion boundary of the immersion area in exposing the first exposure area.

3. The immersion exposure method according to claim 1, wherein the first exposure area and the second exposure area adjoin in a direction perpendicular to the first and second directions.

4. The immersion exposure method according to claim 3, wherein, if the length in the first direction of each of the first exposure area and the second exposure area is CL, the moving width in the first direction of the exposure stage in moving the exposure stage is H, and the diameter of the immersion area is IL, the following expression is satisfied:
H+CL<IL/2

5. The immersion exposure method according to claim 4, wherein the relationship represented by the expression H+CL<IL/2 is controlled by controlling the length CL in the first direction and the moving width H in the first direction.

6. The immersion exposure method according to claim 3, wherein, if the exposure stage is moved at a constant speed of v in exposing the first exposure area, the exposure stage, when being moved to the movement start position of the second exposure area, moves at a constant acceleration in the first direction whose absolute value is a when the movement in the first direction at a speed of v changes to the movement in the second direction at a speed of −v, the exposure stage is moved in the second direction at a constant speed of −v in exposing the second exposure area, the diameter of the immersion area is IL, and the length in the first direction of each of the first exposure area and the second exposure area is CL, the following expression is satisfied;
v²/a<IL−2CL.

7. The immersion exposure method according to claim 6, wherein the relationship represented by the expression v²/a<IL−2CL is controlled by controlling the constant moving speed v and the absolute value a of the acceleration and deceleration.

8. An immersion exposure apparatus comprising:
an exposure stage which holds a substrate to be exposed;
a mask holding mechanism which is configured to hold a photomask;
an optical projection system which is configured to project a pattern of the photomask on the substrate and expose the pattern; and
an immersion area forming mechanism which is configured to form a liquid immersion area between a projection lens of the optical projection system and the substrate and which forms an immersion area whose diameter is larger than v²/a<IL−2CL, if the maximum length in the scanning direction of an exposure area exposed in one scan is CL, the absolute value of the speed of the exposure stage in the scanning exposure is v, the absolute value of the acceleration and deceleration in the scanning direction of the exposure stage during the movement of the exposure stage between the scanning exposure and the next scanning exposure is a,
wherein the optical projection system scans and exposes the pattern of the photomask via the immersion area above the substrate at a constant speed, while the exposure stage is being moved with respect to the projection lens.

9. The immersion exposure apparatus according to claim 8, wherein the mask holding mechanism includes a mask stage and moves the photomask according to the horizontal movement of the mask stage.

10. The immersion exposure apparatus according to claim 8, further comprising a lighting system.

11. The immersion exposure apparatus according to claim 10, wherein the lighting system has a slit for setting the shape of an irradiation slit area.

12. The immersion exposure apparatus according to claim 8, wherein the immersion area forming mechanism includes a water supply and recovery mechanism which supplies and recovers water to and from the immersion area between the substrate and the projection lens and supplies and discharges water in synchronization with the scanning exposure.

13. An immersion exposure apparatus comprising:
an exposure stage which holds a substrate to be exposed;
a mask holding mechanism which is configured to hold a photomask;
an optical projection system which is configured to project a pattern of the photomask on the substrate and expose the pattern; and
an immersion area forming mechanism which is configured to form a liquid immersion area between a projection lens of the optical projection system and the substrate and which forms an immersion area whose diameter IL is larger than (H+CL)×2, if the length in a first direction of each of a first exposure area and a second exposure area is CL and the moving width in the first direction of the exposure stage in moving the exposure stage is H,
wherein the optical projection system scans and exposes the pattern of the photomask via the immersion area above the substrate at a constant speed, while the exposure stage is being moved with respect to the projection lens.

14. The immersion exposure apparatus according to claim 13, wherein the mask holding mechanism includes a mask stage and moves the photomask according to the horizontal movement of the mask stage.

15. The immersion exposure apparatus according to claim 13, further comprising a lighting system.

16. The immersion exposure apparatus according to claim 15, wherein the lighting system has a slit for setting the shape of an irradiation slit area.

17. The immersion exposure apparatus according to claim 13, wherein the immersion area forming mechanism includes a water supply and recovery mechanism which supplies and recovers water to and from the immersion area between the substrate and the projection lens and supplies and discharges water in synchronization with the scanning exposure.
